(19) United States
(12) Patent Application Publication
(10) Pub. No.: US 2009/0159624 A1
(43) Pub. Date: Jun. 25, 2009

(54) Roof rack features enabled by active materials

(75) Inventors: Nancy L. Johnson, Northville, MI (US); Alan L. Browne, Grosse Pointe, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/961,250

(22) Filed: Dec. 20, 2007

(51) Int. Cl. B60R 9/045; B60R 9/04; B60R 9/05; B60R 9/048

(52) U.S. Cl. 224/316; 224/321

(57) ABSTRACT

Roof rack features enabled by active materials are described. A concealment assembly for concealing a roof rack comprises a member configured to have a first form and a second form, wherein the first form is configured to conceal the roof rack and the second form is configured to expose the roof rack; and an active material in operable communication with the member, wherein the active material is capable of undergoing a change in a property upon receipt of an activation signal, wherein the change in the property is effective to transition the member from the first form to the second form.

### BACKGROUND

This disclosure generally relates to roof rack features, and more particularly, to roof rack features enabled by active materials.

Roof/luggage racks are currently employed to allow cargo and cargo containers to be stored on the roofs of vehicles. The attachment of cargo or cargo containers to the roof racks can undesirably require manpower. For example, a clamp mounted to a cargo container can be used to attach the cargo container to a roof rack by physically tightening the clamp onto a rail of the roof rack. Current roof racks also suffer from the drawback of being non-aesthetically pleasing.

Another problem associated with roof racks is that airflow over, under, and/or around a roof rack can produce a significant amount of noise and can also affect many aspects of vehicle performance, including vehicle drag. Vehicle drag can affect the fuel economy of a vehicle. As used herein, the term “airflow” refers to the motion of air around and through parts of a vehicle relative to either the exterior surface of the vehicle or surfaces of elements of the vehicle along which exterior airflow can be directed such as surfaces in the engine compartment. The term “drag” refers to the resistance caused by friction in a direction opposite that of the motion of the center of gravity for a moving body in a fluid.

It is therefore desirable to develop roof rack systems to which cargo, cargo containers, etc. can more easily be attached. It is also desirable to improve the appearance and aerodynamics and to reduce the noise associated with airflow through and around such roof rack systems.

### SUMMARY

Disclosed herein are roof rack features enabled by active materials. In an embodiment, a roof rack system comprises a member in operable communication with an active material, wherein the active material is configured to undergo a change in a property upon receipt of an activation signal.

In another embodiment, a concealment assembly for concealing a roof rack comprises a member configured to have a first form and a second form, wherein the first form is configured to conceal the roof rack and the second form is configured to expose the roof rack; and an active material in operable communication with the member, wherein the active material is capable of undergoing a change in a property upon receipt of an activation signal, wherein the change in the property is effective to transition the member from the first form to the second form.

In yet another embodiment, an air control device for a roof rack of a vehicle comprises a body portion having a surface, wherein the body portion is operably positioned adjacent to the roof rack; and an active material in operative communication with the at least one surface of the body portion, wherein the active material is capable of undergoing a change in a property upon receipt of an activation signal, and wherein an airflow across the air control device changes with the change in the property of the active material.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1a depicts a top plan view of a roof rack recessed beneath a roof of a vehicle and hidden beneath concealment flaps enabled by an active material;

FIG. 1b depicts a top plan view of the roof rack of FIG. 1a deployed above the roof of a vehicle, wherein the roof rack is no longer hidden by the concealment flaps;

FIG. 2a depicts a side plan view of a roof rack on top of a vehicle hidden by side concealment flaps that are enabled by an active material;

FIG. 2b depicts a side plan view of the roof rack of FIG. 2a, which is no longer hidden by the side concealment flaps;

FIG. 3a depicts a perspective view of a roof rack having a positive seating feature enabled by an active material, wherein an object is placed on top of the roof rack;

FIG. 3b depicts a perspective view of the roof rack of FIG. 3a after the positive seating feature has conformed to the shape of the object placed on top of the roof rack;

FIG. 4a depicts a cross-sectional view of a variable shaped hole of a roof rack having a liner on its wall comprising an active material;

FIG. 4b depicts a perspective view of a prong positioned adjacent to the variable shaped hole of FIG. 4a;

FIG. 4c depicts a cross-sectional view of the variable shaped hole of FIG. 4b after its liner has changed shape to conform to the shape of the prong such that the hole and the prong are interlocked;

FIG. 5a depicts a perspective view of a prong comprising an active material; and

FIG. 5b depicts a cross-sectional view of the prong of FIG. 5b inserted in a hole, wherein the shape of an end of the prong has changed to conform to the shape of the hole such that the prong and the hole are interlocked.

### DETAILED DESCRIPTION

Roof rack features are described herein that can be enabled by active materials in operable communication with the roof rack features. As used herein, the term “roof rack” refers to a structure positioned near a roof of a vehicle for attaching objects to the vehicle. Exemplary roof rack features include, but are not limited to, a concealment assembly for hiding the roof rack, an air control device for reducing the noise and/or improving the aerodynamics of the roof rack, a positive seating feature for docking cargo/cargo container on the roof rack, a reversible deployment feature for deploying and stowing the roof rack, a mechanism for attaching the roof rack elements to the vehicle, and a grabbing/engaging/locking feature for holding the cargo/cargo container on the roof rack, e.g., a smart hook for reversibly engaging a loop mounted on the cargo/cargo container, variable shaped holes for reversibly interlocking with prongs mounted on the cargo/cargo container, and variable shaped prongs mounted on the cargo/cargo container for reversibly interlocking with holes of a roof rack. Several of these features make the attachment of the cargo/cargo container to the roof rack easier to handle and alleviate concerns that the cargo/cargo container could detach from the roof rack in response to vehicle movements. In addition, some of these features make the attachment of the roof rack to the vehicle itself easier to achieve and can ensure that the roof rack does not detach from the vehicle.

The term “active material” (also called “smart material”) as used herein refers to several different classes of materials all of which exhibit a change in at least one property when subjected to at least one activation signal. Examples of active material properties that can change include, but are not limited to, shape, stiffness, dimension, shape orientation, flexural modulus, phase, and the like. Depending on the particular active material, the activation signal can take the form of, for example, an electric current, a temperature change, a magnetic field, a mechanical loading or stressing, or the like. In various embodiments, the activation signal can be generated by a controller in response to a user of a vehicle operating an activation button, thus causing a property of the active material to change. A deactivation signal could also be generated in a similar manner to reverse the change in the property of the active material. In alternative embodiments, the controller is in operable communication with a sensor and generates the activation signal in response to the sensor detecting a change in a condition of the vehicle. As a result of receiving the activation signal, the active material undergoes a reversible change.

Suitable active materials for enabling the roof rack features include, but are not limited to, shape memory alloys (“SMAs”; e.g., thermal and stress activated shape memory alloys and magnetic shape memory alloys (MSMA)), electroactive polymers (EAPs) such as dielectric elastomers, ionic polymer metal composites (IPMC), piezoelectric materials (e.g., polymers, ceramics), shape memory polymers (SMPs), shape memory ceramics (SMCs), baroplastics, magnetorheological (MR) materials (e.g., fluids and elastomers), electroheological (ER) materials (e.g., fluids, and elastomers), composites of the foregoing active materials with non-active materials, systems comprising at least one of the foregoing active materials, and combinations comprising at least one of the foregoing active materials. For convenience and by way of example, reference herein will be made to shape memory alloys and shape memory polymers. The shape memory ceramics, baroplastics, and the like, can be employed in a similar manner. For example, with baroplastic materials, a pressure induced mixing of nanophase domains of high and low glass transition temperature (Tg) components effects the shape change. Baroplastics can be processed at relatively low temperatures repeatedly without degradation. SMCs are similar to SMAs but can tolerate much higher operating temperatures than can other shape-memory materials. An example of a SMC is a piezoelectric material.

Shape memory materials have the ability to return to their original shape upon the application or removal of external stimuli. Thus, shape memory materials can be used in actuators to apply force and achieve a desired motion. Active material actuators offer the potential for a reduction in actuator size, weight, volume, cost, noise, and an increase in robustness in comparison with traditional electromechanical and hydraulic means of actuation. Ferromagnetic SMA's, for example, exhibit rapid dimensional changes of up to several percent in response to (and proportional to the strength of) an applied magnetic field. However, these changes are one-way changes and use the application of either a biasing force or a field reversal to return the ferromagnetic SMA to its starting configuration.

Shape memory alloys are alloy compositions with at least two different temperature-dependent phases or polarity. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is often called the austenite finish temperature (A_{f}). When the shape memory alloy is in the austenite phase and is cooled, it begins to change into the martensite phase, and the temperature at which this phenomenon starts is often referred to as the martensite start temperature (Mₛ). The temperature at which austenite finishes transforming to martensite is often called the martensite finish temperature (M_{f}). The range between Aₛ and A_{f} is often referred to as the martensite-to-austenite transformation temperature range while that between Mₛ and M_{f} is often called the austenite-to-martensite transformation temperature range. It should be noted that the above-mentioned transition temperatures are functions of the stress experienced by the SMA sample. Generally, these temperatures increase with increasing stress. In view of the foregoing properties, deformation of the shape memory alloy is preferably at or below the austenite start temperature (at or below Aₛ). Subsequent heating above the austenite start temperature causes the deformed shape memory material sample to begin to revert back to its original (nonstressed) permanent shape until completion at the austenite finish temperature. Thus, a suitable activation input or signal for use with shape memory alloys is a thermal activation signal having a magnitude that is sufficient to cause transformations between the martensite and austenite phases.

The temperature at which the shape memory alloy remembers its high temperature form (i.e., its original, nonstressed shape) when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery over a wider temperature range. The start or finish of the transformation can be controlled to within several degrees depending on the desired application and alloy composition. The mechanical properties of the shape memory alloy vary greatly over the temperature range spanning their transformation, typically providing shape memory effect and superelastic effect. For example, in the martensite phase a lower elastic modulus than in the austenite phase is observed. Shape memory alloys in the martensite phase can undergo large deformations by realigning the crystal structure arrangement with the applied stress. The material will retain this shape after the stress is removed. In other words, stress induced phase changes in SMA are two-way by nature, application of sufficient stress when an SMA is in its austenitic phase will cause it to change to its lower modulus Martensitic phase. Removal of the applied stress will cause the SMA to switch back to its Austenitic phase, and in so doing, recovering its starting shape and higher modulus.

Exemplary shape memory alloy materials include, but are not limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, combinations comprising at least one of the foregoing alloys, and so forth. The alloys can be binary, ternary, or any higher order so long as the alloy composition exhibits a shape memory effect, erg., change in shape, orientation, yield strength, flexural modulus, damping capacity, superelasticity, and/or similar properties. Selection of a suitable shape memory alloy composition depends, in part, on the temperature range of the intended application.

The recovery to the austenite phase at a higher temperature is accompanied by very large (compared to that needed to deform the material) stresses, which can be as high as the inherent yield strength of the austenite material, sometimes up to three or more times that of the deformed martensite phase. For applications that require a large number of operating cycles, a strain of less than or equal to about 4% or of the deformed length of wire used can be obtained. This percentage can increase up to 8% for applications with a low number of cycles. This limit in the obtainable strain places significant constraints in the application of SMA actuators where space is limited.

MSMAs are alloys; often composed of Ni—Mn—Ga, that change shape due to strain induced by a magnetic field. MSMAs have internal variants with different magnetic and crystallographic orientations. In a magnetic field, the proportions of these variants change, resulting in an overall shape change of the material. An MSMA actuator generally requires that the MSMA material be placed between coils of an electromagnet. Electric current running through the coil induces a magnetic field through the MSMA material, causing a change in shape.

As previously mentioned, other exemplary shape memory materials are shape memory polymers (SMPs). A shape memory polymer is a polymeric material that exhibits a change in a property, such as a modulus or dimension (two properties of the roof rack features described herein that can undergo change) or a combination comprising at least one of the foregoing properties in combination with a change in its a microstructure and/or morphology upon application of an activation signal. Shape memory polymers can be thermoresponsive (i.e., the change in the property is caused by a thermal activation signal delivered either directly via heat supply or removal, or indirectly via a vibration of a frequency that is appropriate to excite high amplitude vibrations at the molecular level which lead to internal generation of heat), photoresponsive (i.e., the change in the property is caused by an electromagnetic radiation activation signal), moisture-responsive (i.e., the change in the property is caused by a liquid activation signal such as humidity, water vapor, or water), chemo-responsive (i.e. responsive to a change in the concentration of one or more chemical species in its environment; e.g., the concentration of H⁺ ion—the pH of the environment), or a combination comprising at least one of the foregoing.

Generally, SMPs are phase segregated co-polymers comprising at least two different units, which can be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment can be (semi-)crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n-1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, “predetermined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it can be possible to demonstrate multiple permanent shapes. Similarly using a layered or composite approach, a combination of multiple SMPs can demonstrate transitions between multiple temporary and permanent shapes.

SMPs exhibit a dramatic drop in modulus when heated above the glass transition temperature of that of their constituents that has a lower glass transition temperature. Because this is a thermally activated property change, these materials are not well suited for rapid activation. If loading/deformation is maintained while the temperature is dropped, the deformed shape can be set in the SMP until it is reheated while under no load to return to its as-molded original shape.

The active material can also comprise a piezoelectric material. Also, in certain embodiments, the piezoelectric material can be configured as an actuator for providing rapid deployment. As used herein, the term “piezoelectric” is used to describe a material that mechanically deforms (changes shape) when a voltage potential is applied, or conversely, generates an electrical charge when mechanically deformed. Piezoelectrics exhibit a small change in dimensions when subjected to the applied voltage, with the response being proportional to the strength of the applied field and being quite fast (capable of easily reaching the thousand hertz range). Because their dimensional change is small (e.g., less than 0.1%), to dramatically increase the magnitude of dimensional change they are usually used in the form of piezo ceramic unimorph and bi-morph flat patch actuators which are constructed so as to bow into a concave or convex shape upon application of a relatively small voltage. The morphing/bowing of such patches within the seat is suitable for vibratory-tactile input to the driver.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion. Unimorphs can exhibit a strain of as high as about 10%, but generally can only sustain low loads relative to the overall dimensions of the unimorph structure. In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Inorganic compounds, organic compounds, and metals are exemplary piezoelectric materials. With regard to organic materials, all of the polymeric materials with noncentrosymmetric structure and large dipole moment group(s) on the main chain or on the side-chain, or on both chains within the molecules, can be used as candidates for the piezoelectric film. Examples of suitable polymers include, but are not limited to, poly(sodium 4-styrenesulfonate) (“PSS”), poly S-119 (Poly(vinylamine) backbone azo chromophore), and their derivatives; polyfluorocarbines, including polyvinylidene fluoride (“PVDF”), its co-polymer vinylidene fluoride (“VDF”), trifluorethylene (TrFE), and their derivatives; polychlorocarbons, including poly(vinylchloride) (“PVC”), polyvinylidene chloride (“PVC2”), and their derivatives; polyacrylonitriles (“PAN”) and their derivatives; polycarboxylic acids, including poly (methacrylic acid (“PMA”), and their derivatives; polyureas and their derivatives; polyurethanes (“PUE”) and their derivatives; bio-polymer molecules such as poly-L-lactic acids and their derivatives, and membrane proteins, as well as phosphate bio-molecules; polyanilines and their derivatives, and all of the derivatives of tetraamines; polyimides, including Kapton® molecules and polyetherimide (“PEI”), and their derivatives; all of the membrane polymers; poly (N-vinyl pyrrolidone) (“PVP”) homopolymer and its derivatives and random PVP-co-vinyl acetate (“PVAc”) copolymers; all of the aromatic polymers with dipole moment groups in the main-chain or side-chains, or in both the main-chain and the side-chains; and combinations comprising at least one of the foregoing.

Further piezoelectric materials can include Pt, Pd, Ni, T, Cr, Fe, Ag, Au, Cu, and metal alloys comprising at least one of the foregoing, as well as combinations comprising at least one of the foregoing. These piezoelectric materials can also include, for example, metal oxides such as SiO₂, Al₂O₃, ZrO₂, TiO₂, SrTiO₃, PbTiO₃, BaTiO₃, FeO₃, Fe₃O₄, ZnO, and combinations comprising at least one of the foregoing; and Group VIA and IIB compounds such as CdSe, CdS, GaAs, AgCaSe₂, ZnSe, GaP, InP, ZnS, and combinations comprising at least one of the foregoing.

MR fluids is a class of smart materials whose rheological properties can rapidly change upon application of a magnetic field (e.g., property changes of several hundred percent can be effected within a couple of milliseconds), making them quite suitable in locking in (constraining) or allowing the relaxation of shapes/deformations through a significant change in their shear strength, such changes being usefully employed with grasping and release of objects in embodiments described herein. Exemplary shape memory materials also comprise magnetorheological (MR) and ER polymers. MR polymers are suspensions of micrometer-sized, magnetically polarizable particles (e.g., ferromagnetic or paramagnetic particles as described below) in a polymer (e.g., a thermoset elastic polymer or rubber). Exemplary polymer matrices include, but are not limited to, poly-alpha-olefins, natural rubber, silicone, polybutadiene, polyethylene, polyisoprene, and combinations comprising at least one of the foregoing.

The stiffness and potentially the shape of the polymer structure are attained by changing the shear and compression/tension moduli by varying the strength of the applied magnetic field. The MR polymers typically develop their structure when exposed to a magnetic field in as little as a few milliseconds, with the stiffness and shape changes being proportional to the strength of the applied field. Discontinuing the exposure of the MR polymers to the magnetic field reverses the process and the elastomer returns to its lower modulus state. Packaging of the field generating coils, however, creates challenges.

MR fluids exhibit a shear strength which is proportional to the magnitude of an applied magnetic field, wherein property changes of several hundred percent can be effected within a couple of milliseconds. Although these materials also face the issues packaging of the coils necessary to generate the applied field, they can be used as a locking or release mechanism, for example, for spring based grasping/releasing.

Suitable MR fluid materials include ferromagnetic or paramagnetic particles dispersed in a carrier, e.g., in an amount of about 5.0 volume percent (vol %) to about 50 vol % based upon a total volume of MR composition. Suitable particles include, but are not limited to, iron; iron oxides (including Fe₂O₃ and Fe₃O₄); iron nitride; iron carbide; carbonyl iron; nickel; cobalt; chromium dioxide; and combinations comprising at least one of the foregoing; e.g., nickel alloys; cobalt alloys; iron alloys such as stainless steel, silicon steel, as well as others including aluminum, silicon, cobalt, nickel, vanadium, molybdenum, chromium, tungsten, manganese and/or copper.

The particle size can be selected so that the particles exhibit multiple magnetic domain characteristics when subjected to a magnetic field. Particle diameters (e.g., as measured along a major axis of the particle) can be less than or equal to about 1,000 micrometers (μm) (e.g., about 0.1 micrometer to about 1,000 micrometers), specifically about 0.5 to about 500 micrometers, or more specifically about 10 to about 100 micrometers.

The viscosity of the carrier can be less than or equal to about 100,000 centipoise (cPs) (e.g., about 1 cPs to about 100,000 cPs), specifically, about 250 cPs to about 10,000 cPs, or more specifically about 500 cPs to about 1,000 cPs. Possible carriers (e.g., carrier fluids) include organic liquids, especially non-polar organic liquids. Examples of suitable organic liquids include, but are not limited to, oils (e.g., silicon oils, mineral oils, paraffin oils, white oils, hydraulic oils, transformer oils, and synthetic hydrocarbon oils (e.g., unsaturated and/or saturated)); halogenated organic liquids (such as chlorinated hydrocarbons, halogenated paraffins, perfluorinated polyethers and fluorinated hydrocarbons); diesters; polyoxyalkylenes; silicones (e.g., fluorinated silicones); cyanoalkyl siloxanes; glycols; and combinations comprising at least one of the foregoing carriers.

Aqueous carriers can also be used, especially those comprising hydrophilic mineral clays such as bentonite or hectorite. The aqueous carrier can comprise water or water comprising a polar, water-miscible organic solvent (e.g., methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like), as well as combinations comprising at least one of the foregoing carriers. The amount of polar organic solvent in the carrier can be less than or equal to about 5.0 vol % (e.g., about 0.1 vol % to about 5.0 vol %), based upon a total volume of the MR fluid or more specifically about 1.0 vol % to about 3.0%. The pH of the aqueous carrier can be less than or equal to about 13 (e.g., about 5.0 to about 13) or more specifically about 8.0 to about 9.0.

When the aqueous carriers comprises natural and/or synthetic bentonite and/or hectorite, the amount of clay (bentonite and/or hectorite) in the MR fluid can be less than or equal to about 10 percent by weight (wt %) based upon a total weight of the MR fluid, specifically about 0.1 wt % to about 8.0 wt %, more specifically about 1.0 wt % to about 6.0 wt %, or even more specifically about 2.0 wt % to about 6.0 wt %.

Optional components in the MR fluid include clays (e.g., organoclays), carboxylate soaps, dispersants, corrosion inhibitors, lubricants, anti-wear additives, antioxidants, thixotropic agents, and/or suspension agents. Examples of carboxylate soaps include, but are not limited to, ferrous oleate; ferrous naphthenate; ferrous stearate; aluminum di- and tri-stearate; lithium stearate; calcium stearate: zinc stearate; and/or sodium stearate; surfactants (such as sulfonates, phosphate esters, stearic acid, glycerol monooleate, sorbitan sesquioleate, laurates, fatty acids, fatty alcohols, fluoroaliphatic polymeric esters); coupling agents (such as titanate, aluminate, and zirconate); and combinations comprising at least one of the foregoing. Polyalkylene diols, such as polyethylene glycol, and partially esterified polyols can also be included.

Electrorheological fluids (ER) are similar to MR fluids in that they exhibit a change in shear strength when subjected to an applied field, in this case a voltage rather than a magnetic field. Response is quick and proportional to the strength of the applied field. It is, however, an order of magnitude less than that of MR fluids and several thousand volts are typically required.

Electronic electroactive polymers (EAPs) are a laminate of a pair of electrodes with an intermediate layer of low elastic modulus dielectric material. Applying a potential between the electrodes squeezes the intermediate layer causing it to expand in plane. They exhibit a response proportional to the applied field and can be actuated at high frequencies. EAP patch vibrators have been demonstrated and are suitable for providing the haptic-based alert such as for use in the seat for vibratory input to the driver and/or occupants.

Electroactive polymers include those polymeric materials that exhibit piezoelectric, pyroelectric, or electrostrictive properties in response to electrical or mechanical fields. An example of an electroactive polymer is an electrostrictive-grafted elastomer with a piezoelectric poly(vinylidene fluoride-trifluoro-ethylene) copolymer. This combination has the ability to produce a varied amount of ferroelectric-electrostrictive molecular composite systems.

Materials suitable for use as an electroactive polymer may include any substantially insulating polymer and/or rubber that deforms in response to an electrostatic force or whose deformation results in a change in electric field. Exemplary materials suitable for use as a pre-strained polymer include, but are not limited to, silicone elastomers, acrylic elastomers, polyurethanes, thermoplastic elastomers, copolymers comprising PVDF, pressure-sensitive adhesives, fluoroelastomers, polymers comprising silicone and acrylic moieties (e.g., copolymers comprising silicone and acrylic moieties, polymer blends comprising a silicone elastomer and an acrylic elastomer, and so forth), and combinations comprising at least one of the foregoing polymers.

Materials used as an electroactive polymer can be selected based on desired material propert(ies) such as a high electrical breakdown strength, a low modulus of elasticity (e.g., for large or small deformations), a high dielectric constant, and so forth. In one embodiment, the polymer can be selected such that is has an elastic modulus of less than or equal to about 100 MPa. In another embodiment, the polymer can be selected such that is has a maximum actuation pressure of about 0.05 megaPascals (MPa) to about 10 MPa, or more specifically about 0.3 MPa to about 3 MPa. In another embodiment, the polymer can be selected such that is has a dielectric constant of about 2 to about 20, or more specifically about 2.5 and to about 12. The present disclosure is not intended to be limited to these ranges. Ideally, materials with a higher dielectric constant than the ranges given above would be desirable if the materials had both a high dielectric constant and a high dielectric strength. In many cases, electroactive polymers can be fabricated and implemented as thin films, e.g., having a thickness of less than or equal to about 50 micrometers.

Electroactive polymers can deflect at high strains, and electrodes attached to the polymers can also deflect without compromising mechanical or electrical performance. Generally, electrodes suitable for use can be of any shape and material provided that they are able to supply a suitable voltage to, or receive a suitable voltage from, an electroactive polymer. The voltage can be either constant or varying over time. In one embodiment, the electrodes adhere to a surface of the polymer. Electrodes adhering to the polymer can be compliant and conform to the changing shape of the polymer. The electrodes can be only applied to a portion of an electroactive polymer and define an active area according to their geometry. Various types of electrodes include structured electrodes comprising metal traces and charge distribution layers, textured electrodes comprising varying out of plane dimensions, conductive greases (such as carbon greases and silver greases), colloidal suspensions, high aspect ratio conductive materials (such as carbon fibrils and carbon nanotubes, and mixtures of ionically conductive materials), as well as combinations comprising at least one of the foregoing.

Exemplary electrode materials can include, but are not limited to, graphite, carbon black, colloidal suspensions, metals (including silver and gold), filled gels and polymers (e.g., silver filled and carbon filled gels and polymers), ionically or electronically conductive polymers, and combinations comprising at least one of the foregoing. It is understood that certain electrode materials can work well with particular polymers but not as well with others. By way of example, carbon fibrils work well with acrylic elastomer polymers while not as well with silicone polymers.

Magnetostrictives are solids that develop a large mechanical deformation when subjected to an external magnetic field. This magnetostriction phenomenon is attributed to the rotations of small magnetic domains in the materials, which are randomly oriented when the material is not exposed to a magnetic field. The shape change is largest in ferromagnetic or ferromagnetic solids (e.g., Terfenol-D). These materials possess a very fast response capability, with the strain proportional to the strength of the applied magnetic field, and they return to their starting dimension upon removal of the field. However, these materials have maximum strains of about 0.1 to about 0.2 percent.

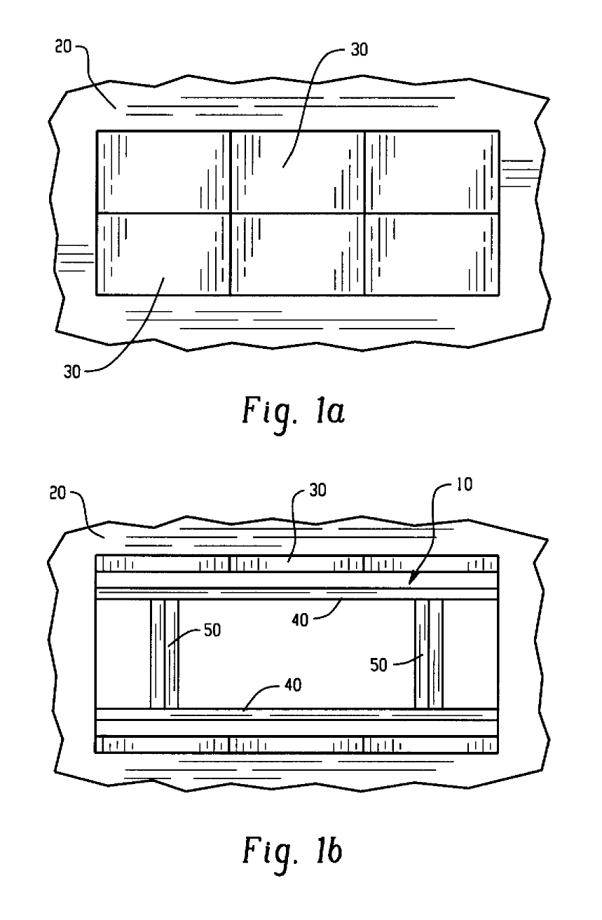

Particular embodiments of roof rack features enabled by active materials are illustrated in FIGS. 1a-5c. Turning now to FIGS. 1a and 1b, a concealment assembly for hiding a roof rack 10 and thus improving the appearance of a vehicle containing the roof rack 10 is shown. The roof rack 10 in FIG. 1 can be stowed in a recessed position beneath the roof 20 of a vehicle where it can be concealed beneath concealment members, i.e., flaps 30 in this embodiment. An active material is in operable communication with the concealment flaps 30. As described above, the active material can undergo a change in a property upon receipt of an activation signal. Suitable active materials and their properties are described above, with shape memory materials being preferred. The active material can be present in the concealment flaps 30 themselves or in a coating applied to the surface of the concealment flaps 30.

In response to the activation signal, the concealment flaps 30 can change from a first form in which they conceal the roof rack 10 to a second form in which they expose the roof rack 10, as depicted in FIG. 1b. This transformation from the first form to the second form can occur as a result of a property change in the active material. For example, the stiffness of the active material could decrease such that the concealment flaps 30 soften, or a dimension or shape of the active material (e.g., a SMP) could change such that the concealment flaps 30 shrink or morph. As a result, the roof rack 10 can be deployed upward through softened concealment flaps or past morphed concealment flaps. This deployment of the roof rack 10 can be effectuated using a deployment device (not shown) comprising, e.g., a mechanical actuator, an electromechanical actuator, an active material actuator, or a combination comprising at least one of the foregoing actuators. As a result, the roof rack 10 becomes accessible to allow cargo or a cargo container to be attached to a member of the roof rack 10. While the roof rack 10 is shown as having side rails 40 and cross rails 50, it could also have hooks and grips for aiding the attachment of the cargo/cargo container.

In an embodiment, the deployment of the roof rack 10 can be button activated. That is, a controller in communication with the concealment flaps 30 and the deployment device can generate the activation signal (examples previously provided) in response to a user operating an activation button or a similar device. The controller can send the activation signal to an activation device configured to cause the change in the property of the active material. A deactivation signal could be generated in a similar manner and sent to the deployment device to cause it to move the roof rack 10 back to its recessed position where it can be stowed. The deactivation signal could also be sent to the activation device to cause the previously changed property of the active material to revert back to its original form. As a result, the concealment flaps 30 would again cover and conceal the roof rack 10 in its stowed position. Additional disclosure related to concealment assemblies enabled by active materials can be found in copending U.S. patent application Ser. No. 11/848,466, entitled “Active Material Based Concealment Assemblies” and filed on Aug. 31, 2007, which is incorporated by reference herein in its entirety.

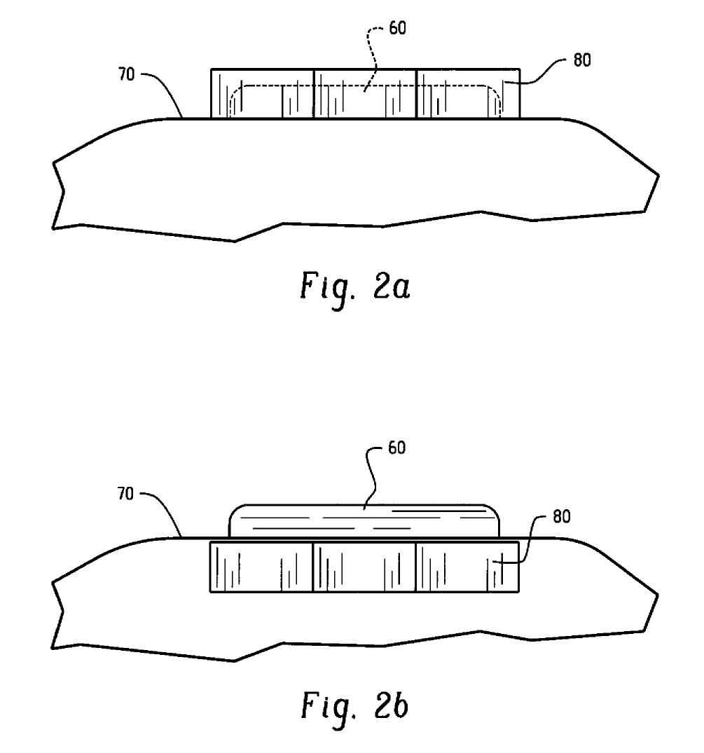

FIGS. 2a and 2b depict another embodiment in which a roof rack 60 is disposed in a fixed position above the roof 70 of a vehicle. The concealment flaps 80 are like the concealment flaps 30 described above with the exception that they can cover the sides rather than the top of the roof rack 60 when desired as shown in FIG. 2a. Further, the concealment flaps 80 can be moved or morphed to reveal the roof rack for use when needed through action of the active material in operable communication with the concealment flaps 30.

In an alternative embodiment, at least one of the concealment flaps 30 can be replaced with an air control device comprising a body portion and an active material in operative communication with at least one surface of the body portion. The active material can be present in a coating applied to a surface of the body portion or in the body portion itself. For example, the active material can be in the form of strips or wires embedded into a surface of the body portion. Suitable active materials and their properties are described above, with shape memory materials being preferred. An activation signal can be sent to the active material to alter a property of the active material to thereby cause the airflow across the air control device to change. For example, the active material can change from a substantially straight shape to a curvilinear shape or vice versa in response to the activation signal. A controller in operable communication with a sensor can generate this activation signal when the sensor detects a change in a condition of the vehicle such as the speed of the vehicle. The controller can send the activation signal to an activation device configured to cause the change in the property of the active material. Accordingly, the air control device can serve to reduce the noise and/or improve the aerodynamics of the roof rack. Additional disclosure related to air control devices enabled by active materials can be found in U.S. patent application Ser. No. 10/893,119 filed on Jul. 15, 2004, which is incorporated by reference herein in its entirety.

In additional embodiments, roof rack elements such as longitudinal rails can be rotated and/or translated to present a lower aerodynamic profile when not in use. For example, they can be moved to a stowed position in which they lye flush against the roof surface or lye within indentations in the roof surface. For such embodiments, an active material, preferably a SMA, can be used to either deploy or stow the air dam elements. A locking mechanism can be used to latch them in place. The locking mechanism can also be released through activation of the SMA. The presence of a locking mechanism provide for the use of a power off hold position and also allows large forces to be applied to the roof rack once in its deployed position. Upon release of the locking mechanism, a bias spring can be employed to return the roof rack to the configuration from which it was moved by SMA activation.

Another feature of a roof rack that can be enabled by an active material is a “positive seating” feature. The active material can be configured in operable communication with a section of the roof rack. Suitable active materials and their properties are described above, with shape memory materials being preferred. The shape of the active material can conform to a shape of an object, e.g., cargo or a cargo container, seated thereon upon receiving an activation signal. As a result, a positive engagement can be created between the roof rack and the object to increase the resistance to sliding of the object (e.g., a tied-down object).

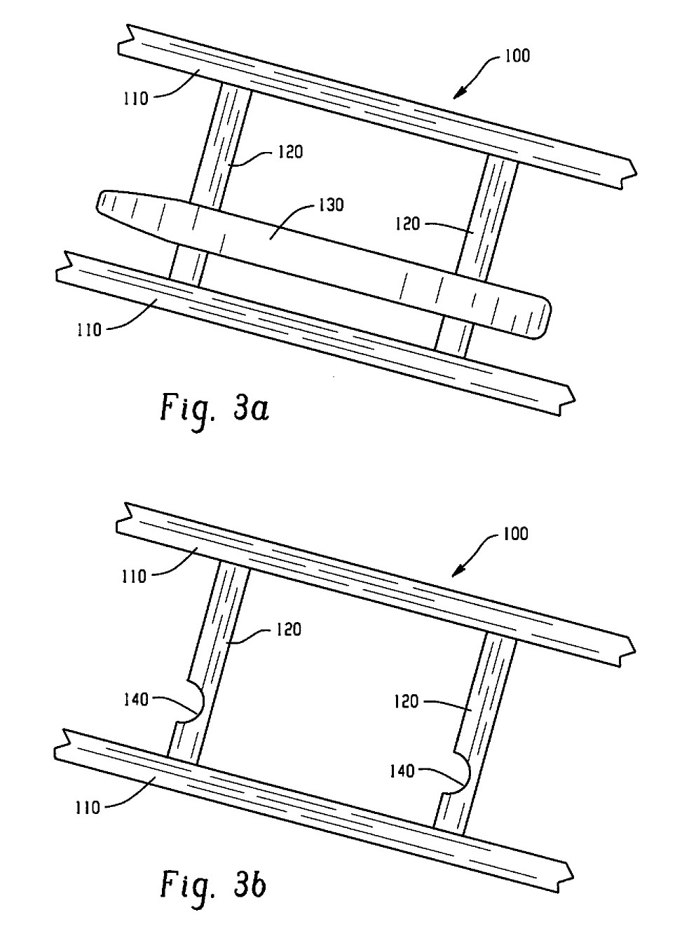

FIGS. 3a and 3b illustrate an embodiment of the positive seating feature described above. The roof rack 100 in FIGS. 3a and 3b includes parallel side rails 110 and cross rails 120 running perpendicular to the side rails 110. It is understood that the roof rack 100 can also include other members, e.g., hooks and grips, for aiding the docking of cargo/cargo container to the roof rack 100. Sections of the roof rack can include an active material or can be coated with or placed in contact with the active material to enable the positive seating feature. For example, pads comprising the active material can be placed on a surface of a roof rack element. A ski 130 is shown positioned across the cross rails 120 as exemplary cargo. The shape of the active material can conform to the shape of the ski 130 upon receiving an activation signal, leading to an indentation 140 in the cross rail 120 beneath the ski 130. By way of example, the active material can be a SMP, and the activation signal can be a thermal signal. Thus, the thermal signal can heat the active material, causing it to soften (i.e., its flexural modulus decreases) and conform to the shape of the ski 130 under gravity loading. The active material can then be cooled by removing the activation signal to lock in the indentation shape 140. In an embodiment, the positive seating feature can be button activated as described in relation to previous embodiments.

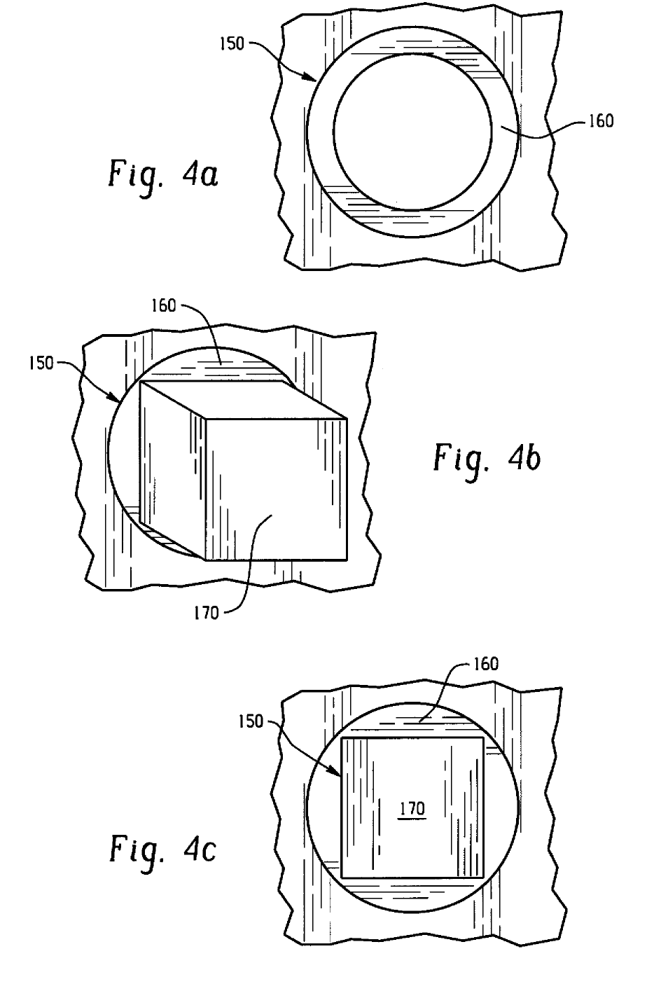

Additional embodiments are contemplated in which active materials enable roof rack elements to be reversibly attached to a roof of a vehicle and/or to each other. For example, cross car members and longitudinal rails can be reversibly attached to each other. Still more embodiments are contemplated in which active materials enable cargo/cargo containers to be reversibly attached to a roof rack. For example, the ease with which cargo/cargo container can be reversibly mounted on a roof rack or roof rack elements can be attached to each other or to a roof of a vehicle can also be improved through the use of additional features referred to herein as the “variable shaped hole” and the “variable shaped prong”. FIGS. 4a and 4b illustrate the functionality of the variable shaped hole (VSH) 150. As shown, a liner 160 can be positioned along the inner wall of the VSH 150. This liner 160 can comprise an active material. Alternatively, the active material can be present within the inner wall of the VSH 150. Suitable active materials and their properties are described above, with shape memory materials being preferred. Although the diameter of the VSH 150 is shown as being relatively uniform, it could also have an irregular geometry. For example, it could decrease in size from top to bottom or vice versa.

As depicted in FIG. 4b, a prong 170 can be positioned adjacent to the VSH 150. The prong 170 could be mounted on cargo/cargo container to provide for attachment to the roof rack. The geometry of prong 170 can vary in shape but is preferably larger in diameter than the diameter of the VSH 150 or at least has a minimum diameter larger than the minimum diameter of the VSH 150. As such, the prong 170 does not initially fit within VSH 150. However, in response to receiving an activation signal, the active material can undergo a change in shape such that its shape conforms to the shape of the prong 170. As a result, the shape of the wall of the liner 160 conforms to the geometry of the prong 170, as shown in FIG. 4c. For example, the active material could be a SMP that is heated by a thermal activation signal to decrease its flexural modulus. As a result, the SMP could flow around the geometry of prong 170 as the prong 170 is inserted into the VSH 150. The SMP could then be cooled to increase the flexural modulus and thus create a substantial mechanical interlock, i.e., positive hold, between the VSH 150 and the prong 170. As a result, the shape of the inner wall of the liner 160 would conform to the geometry of the prong 170, as shown in FIG. 4c.

In one embodiment, the change in shape of the VSH 150 can be button activated. That is, a controller can be configured to generate the activation signal in response to a user operating an activation button or a similar device. The controller can send the activation signal to an activation device configured to cause the change in the shape of the active material. The controller also can be configured to generate a release signal in response to a user operating a release button. Upon receipt of the release signal, the active material can soften, allowing the prong 170 to be removed from the VSH 150.

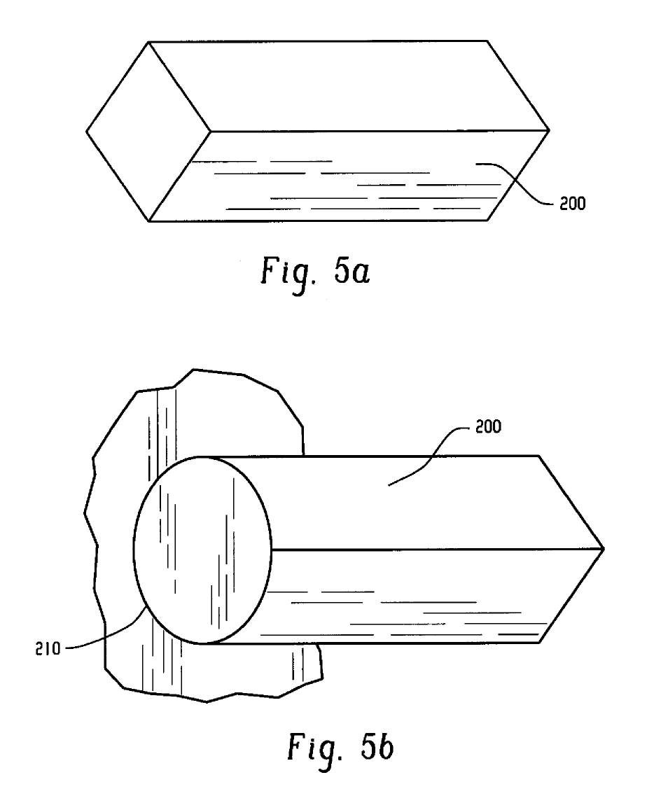

FIG. 5a depicts a variable shaped prong (VSP) 200 that functions similarly to the previously described variable shaped hole. The VSP 200 can be mounted on cargo/cargo container to be attached to a roof rack of a vehicle or on a roof rack element to be attached to a roof of a vehicle or to each other. The VSP 200 can be coated with an active material or, as shown in FIG. 5a, the VSP 200 can comprise the active material in cases of light load applications. Examples of suitable active materials are described above, with shape memory materials being preferred. FIG. 5b depicts the insertion of the VSP 200 into a hole 210 disposed in a roof rack. The VSP 200 and/or the hole 210 can have irregularities in their original geometries such as variations in diameter along their lengths. As such, the VSP 200 is initially incapable of being inserted in the hole 210. However, a property, e.g., flexural modulus, of the active material in communication with the VSP 200 or the hole 210 can change upon receipt of an activation signal e.g., heat, to cause the geometry of the VSP 200 to conform to the shape of the hole 210 or vice versa. For example, the exterior of the VSP 200 and the interior of the hole 210 can be become circular shaped such that they mate with each other. As a result, the VSP 200 can be inserted in the hole 210. Upon cooling, the active material can harden to form a mechanical interlock between the VSP 200 and the hole 210, thus preventing pullout. The VSP 200 can be released from the hole 210 when the active material is heated again and softened in response to a release signal. The activation and release signals can be generated as described in the VSH embodiment.

It is understood that the number of concealment flaps, airflow control devices, positive seating areas, holes present on the roof rack, and prongs present on cargo/cargo container can vary, as can their positions and their sizes. For example, the holes and prongs can range in size from, e.g., 1 millimeter, to, e.g., several centimeters. Moreover, any number of roof rack features described herein can be combined.

The embodiments described herein can be embodied in the form of computer-implemented processes and apparatuses for practicing those processes. Embodiments can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment can also be embodied in the form of computer program code, whether stored in a storage medium, loaded into and/or executed by a computer, or transmitted over some transmission medium, such as over electrical wiring or cable, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

As used herein, the terms “a” and “an” do not denote a limitation of quantity, hut rather denote the presence of at least one of the referenced items. Reference throughout the specification to “one embodiment”, “another embodiment”, “an embodiment”, and so forth means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. Unless defined otherwise, technical and scientific terms used herein have the same meaning as is commonly understood by one of skill in the art to which this invention belongs.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A concealment assembly for concealing a roof rack, comprising:
a member configured to have a first form and a second form, wherein the first form is configured to conceal the roof rack and the second form is configured to expose the roof rack; and
an active material in operable communication with the member, wherein the active material is capable of undergoing a change in a property upon receipt of an activation signal, wherein the change in the property is effective to transition the member from the first form to the second form.

2. The concealment assembly of claim 1, wherein the active material comprises a shape memory alloy, an electroactive polymer, an ionic polymer metal composite, a piezoelectric material, a shape memory polymer, a shape memory ceramic, a baroplastic, a magnetorheological material, an electrorheological material, a composite of at least one of the foregoing active materials with a non-active material, and a combination comprising at least one of the foregoing active materials.

3. The concealment assembly of claim 1, wherein the member comprises the active material.

4. The concealment assembly of claim 1, wherein the active material is applied to a surface of the member.

5. The concealment assembly of claim 1, wherein the roof rack comprises a hook, a rail, a grip, a cross rail, or a combination comprising at least one of the foregoing.

6. The concealment assembly of claim 1, wherein the roof rack is in a recessed position beneath, flush with an exterior surface of, or in close proximity to a roof of a vehicle when the member is in the first form, and wherein the roof rack is in a deployed position above the roof when the member is in the second form.

7. The concealment assembly of claim 1, further comprising a controller configured to generate the activation signal in response to a user operating an activation button.

8. The concealment assembly of claim 1, further comprising a deployment device configured to deploy the roof rack in one step and to stow the roof rack in another step, wherein the deployment device comprises a mechanical actuator, an electromechanical actuator, an active material actuator, or a combination comprising at least one of the foregoing.

9. The concealment assembly of claim 1, wherein the roof rack is disposed in a fixed position above a roof of a vehicle, and wherein the first form is configured to conceal a side of the roof rack.

10. The concealment assembly of claim 1, wherein the property of the active material is a stiffness, a shape, a dimension, a shape orientation, a phase, or a combination comprising at least one of the foregoing properties.

11. A roof rack system comprising: a roof rack member in operable communication with an active material, wherein the active material is configured to undergo a change in a property upon receipt of an activation signal.

12. The roof rack system of claim 11, wherein the member comprises a hook, a rail, a grip, a cross rail, or a combination comprising at least one of the foregoing.

13. The roof rack system of claim 11, wherein the active material comprises a shape memory alloy, an electroactive polymer, an ionic polymer metal composite, a piezoelectric material, a shape memory polymer, a shape memory ceramic, a baroplastic, a magnetorheological material, an electrorheological material, a composite of at least one of the foregoing active materials with a non-active material, and a combination comprising at least one of the foregoing active materials.

14. The roof rack system of claim 11, wherein the property of the active material is a stiffness, a shape, a dimension, a shape orientation, a phase, or a combination comprising at least one of the foregoing properties.

15. The roof rack system of claim 11, wherein the roof rack member is configured to be reversibly attached to another roof rack member or to a roof of a vehicle when the property of the active material changes.

16. The roof rack system of claim 11, wherein the member comprises the active material.

17. The roof rack system of claim 11, wherein the active material is applied to a surface of the member.

18. The roof rack system of claim 11, wherein the member comprises a hook, and wherein the hook is configured to engage or release a loop of an object when the property of the active material changes.

19. The roof rack system of claim 11, wherein the property is a first shape capable of conforming to a second shape of an object upon receipt of the activation signal.

20. The roof rack system of claim 19, wherein the object is positioned on top of the member, and wherein the member inhibits the object from moving when the first shape of the active material conforms to the second shape of the object.

21. The roof rack system of claim 19, wherein the member comprises a variable shaped hole, and wherein a wall of the hole or a liner on the wall comprises the active material.

22. The roof rack system of claim 21, wherein the object comprises a prong having the second shape, and wherein the first shape of the active material is capable of conforming to the second shape to allow the prong to be inserted in the variable shaped hole upon receipt of the activation signal.

23. The roof rack system of claim 22, wherein the active material undergoes the change in the property to allow the prong to be released from the variable shaped hole upon receipt of a release signal.

24. The roof rack system of claim 11, wherein the member comprises a hole having a first shape, and further comprising an object comprising a prong which comprises the active material or is coated by the active material, wherein the property of the active material is a second shape capable of conforming to the first shape of the hole to allow the prong to be inserted in the hole upon receipt of the activation signal.

25. The roof rack system of claim 24, wherein the active material undergoes the change in the property to allow the prong to be released from the hole upon receipt of a release signal.

26. The roof rack system of claim 11, further comprising a controller configured to generate the activation signal in response to a user operating an activation button.

27. An air control device for a roof rack of a vehicle, comprising:
a body portion having a surface, wherein the body portion is operably positioned adjacent to the roof rack; and
an active material in operative communication with the at least one surface of the body portion, wherein the active material is capable of undergoing a change in a property upon receipt of an activation signal, and wherein an airflow across the air control device changes with the change in the property of the active material.

28. The air control device of claim 27, wherein the active material comprises a shape memory alloy, an electroactive polymer, an ionic polymer metal composite, a piezoelectric material, a shape memory polymer, a shape memory ceramic, a baroplastic, a magnetorheological material, an electrorheological material, a composite of at least one of the foregoing active materials with a non-active material, and a combination comprising at least one of the foregoing active materials.

29. The air control device of claim 27, wherein the property of the active material is a stiffness, a shape, a dimension, a shape orientation, a phase, or a combination comprising at least one of the foregoing properties.

30. The air control device of claim 27, wherein the body portion comprises the active material.

31. The air control device of claim 27, wherein the active material is applied to the surface of the body.

32. The air control device of claim 27, wherein the active material comprises a plurality of strips embedded in the surface.

33. The air control device of claim 27, wherein the active material is capable of changing from a substantially straight shape to a curvilinear shape in response to the activation signal.

34. The air control device of claim 27, further comprising a controller in operable communication with a sensor, wherein the controller is configured to generate the activation signal in response to the sensor detecting a change in a condition of the vehicle.
